(19) United States
(12) Patent Application Publication
(10) Pub. No.: US 2008/0056222 A1
(43) Pub. Date: Mar. 6, 2008

(54) Wireless router connection indicator

(76) Inventor: Nigel Waites, Lakeville, MN (US)

Correspondence Address: BECK AND TYSVER P.L.L.C., 2900 THOMAS AVENUE SOUTH, SUITE 100, MINNEAPOLIS, MN, 55416, US

(21) Appl. No.: 11/511,728

(22) Filed: Aug. 29, 2006

(51) Int. Cl. H04B 7/216

(52) U.S. Cl. 370/342

(57) ABSTRACT

An indicator on the exterior surface of the wireless router is described that shows the current number of wireless connections. The indicator can be a digital display, or a plurality of light or LED sets. If separate lights are used for each connection, the lights could also indicate the connection speed or strength of the relevant connection. With this invention, a person would be able to look at their router and see how many connections have been made. If the router showed two connections, and the user has only a single wireless computer in the home, the user would instantly know that somebody outside the home is connected to his or her network. The router may also allow an alarm limit to be set, whereby an audible alarm can be created if the number of connections to the router exceeds the alarm limit.

### FIELD OF THE INVENTION

The present invention relates to wireless routers. More particular, the present invention relates to a connection indicator on the physical shell of a wireless base station.

### BACKGROUND OF THE INVENTION

Many individuals establish communication networks within their homes or businesses to link computing devices together. These local area networks (or “LANs”) can take the form of a wired network, where cables physically connect devices together, or a wireless network, where wireless communications are used to connect devices. Wired networks typically utilize the Ethernet data link protocol to send messages over physical cables. Because of the limits of the signals that are put forth on an Ethernet cable, each cable has a limited maximum length, such as 700 meters for a standard category five (or “Cat-5”) cable. Repeaters can be used to extend this length. A special type of repeater is an Ethernet hub, which allows an Ethernet network to be wired in a star topology. With an Ethernet hub, every packet is repeated on every cable connected to the hub. Because the Ethernet protocol uses a collision detection system to share bandwidth on the network, a large local area network operating on an Ethernet hub can experience multiple collisions. This results in a decrease in network performance.

To overcome this difficulty, Ethernet switches have become common in LAN topologies. While an Ethernet switch can be wired like an Ethernet hub, the switch does not forward all Ethernet packets onto every connected cable. Rather, switches learn the locations of each device on the local area network, and then forward incoming packets only along that cable on which the intended destination device resides. In this manner, multiple devices can communicate with one another simultaneously using an Ethernet switch without worrying about collisions on the network.

When local area networks need to communicate with a separate network, such as the Internet, a router is used to handle this communication. The router resides on the local area network, and operates as a gateway between the Internet and the LAN. Consequently, routers used in this capacity are often called gateways. Routers are capable of transferring data packets between different networks by altering the destination address of each packet as necessary when switching the packet between networks. Sometimes, a router may also contain technology that allows it to operate as a switch in a local area network as well as a router.

Wireless local area networks do not rely upon physical wires or cables to establish communications between computing devices, but instead use wireless radio signals that are transmitted between the devices. These signals are based upon standard protocols, such as the popular IEEE 802.11 protocols. Generally, each computing device will have a wireless transmitter/receiver in order to communicate with the wireless network. One or more wireless access points on the wireless local area network provide a connection between the wireless LAN and a wired network, such as the Internet. While an access point could take the form of a general-purpose computer with a wireless antenna and a wired connection to the Internet, most access points are now stand-alone, dedicated boxes referred to as wireless routers. These wireless routers, which are also referred to as wireless base stations, are stand-alone devices that contain an antenna to connect to the wireless LAN, a wired connection to the wired network (the Internet), and logic necessary to bridge the wireless and wired networks. A wireless router will often contain logic that allows the router to allow multiple wireless devices to connect simultaneously over a singled, wired connection to the Internet. To aid in this, the wireless router may assign private Internet Protocol (“IP”) network addresses to the devices on the wireless LAN, typically through the use of the Dynamic Host Configuration Protocol (“DHCP”). In addition, many wireless routers are also capable of operating like a wired hub or switch, thereby linking together multiple wired cables so as to form an integral part of the wired local area network.

In wired home networks that use a router, switch, or gateway, the user can easily see what connections are physically made to the network by counting the cables plugged into the device and examining the link and data lights. With wireless networks, there is no similar feedback for the user.

### SUMMARY OF THE INVENTION

The present invention increases the security of a wireless router by providing an indicator on the exterior surface of the wireless router that shows the current number of wireless connections. These can take the form of a number of light/LED indicators, with each light (or set of lights) representing a separate connection to the wireless router. Alternatively, a simple numerical counter on the front panel can be provided that shows how many connections are currently being made to the router. If separate lights are used for each connection, the lights could also indicate the connection speed or the connection strength of the relevant connection. With this invention, a person would be able to look at their wireless router and see how many connections have been made. If the router showed two connections, and they have only a single wireless laptop in the home, they would instantly know that somebody outside the home is connected to their network. In a separate embodiment, an audible alarm sounds on the router when the number of connections made to the wireless router exceeds a predetermined alarm limit.

### BRIEF DESCRIPTION OF THE DRAWINGS

FIG. 1 is a schematic diagram of a prior art wireless home network.

FIG. 2 is a schematic diagram of a wireless home network using the wireless router of the present invention.

FIG. 3 is an alternative embodiment of the present invention wireless router.

FIG. 4 is a third embodiment of the present invention wireless router.

FIG. 5 is a schematic drawing showing the components of the wireless router of FIG. 2.

### DETAILED DESCRIPTION OF THE INVENTION

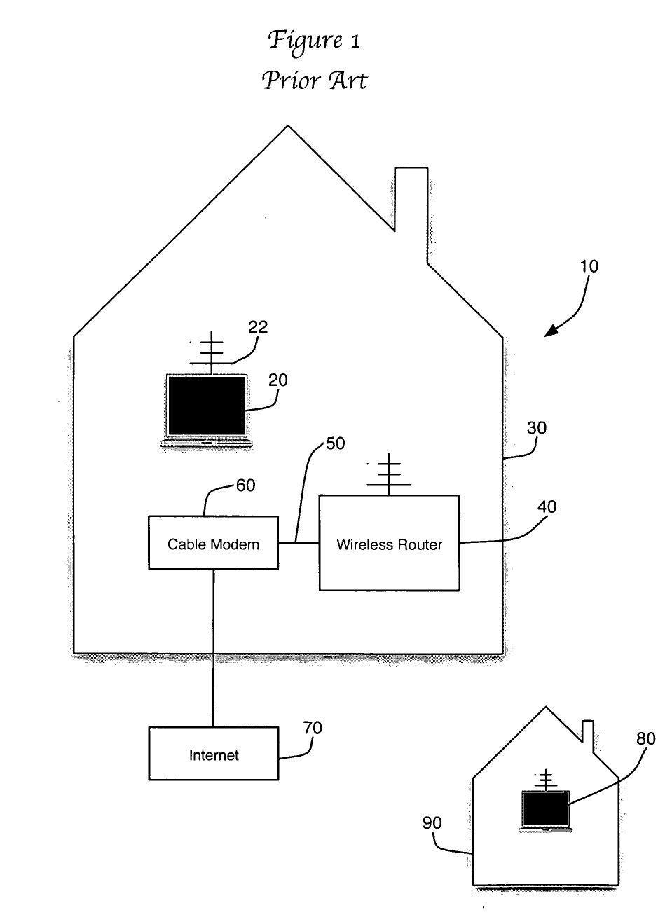

FIG. 1 shows the problems with the prior art wireless routers in the context of a home wireless network 10. In this network, a portable computer 20 with a wireless network antenna 22 is located within a home 30 and is connected to a prior art wireless router 40. The router 40 serves to connect the wireless network 10 to a wired network 50, which connects the wireless router 40 to a cable modem 60 or other Internet gateway device. The cable modem 60 provides the wired network 50 with access to the Internet 70.

When the portable computer 20 or other device connects to the wireless router 40, an authentication process takes place to validate that the wireless client has appropriate permissions to use the router 40. This process uses open and secured protocols defined in the Media Access Layer (MAC) layer, and is called MAC Authentication. Any device that successfully authenticates through the MAC layer will be considered to be connected to the router irrespective of its overall connectivity in the system. When the connection is made, the wireless router 40 may assign a network address to the device by issuing a new DHCP lease. If a device is attempting to connect but cannot due to the fact that incorrect authentication keys are used, the authentication process will show a failure and the router 40 will not consider the device to be connected.

By monitoring authenticated connections or DHCP leases, the prior art router 40 is able to track the number of connections currently being made to it via the wireless network 10. Unfortunately, when a connection is made there is no indication of that connection which is visible when examining the physical prior art router 40. The only way to determine the number of connections on router 40 is to run management software (or access a web-based management page) on a general purpose computer that is able to connect to the wireless router 40, such as via portable computer 20. The software then can download connection information from the wireless router 40, and display this information on the computer's screen.

The problem with this process is that it is complex and time consuming, and consequently is never performed by the vast majority of users who purchase wireless routers 40 for home networks. Furthermore, even when the technique is known, it is generally not performed frequently. Consequently, even sophisticated users are rarely aware of the number of connections currently being made to their wireless network 10.

Because of the nature of wireless networks 10, they are not contained within the walls of a business office or a home 30. This means that a stranger could connect to the router 40 from outside the house 30, such as through a second portable computer 80 found in neighboring house 90. When this occurs, the owner of the wireless router 40 has no easy to understand, visual indication that someone has connected to his or her network 10.

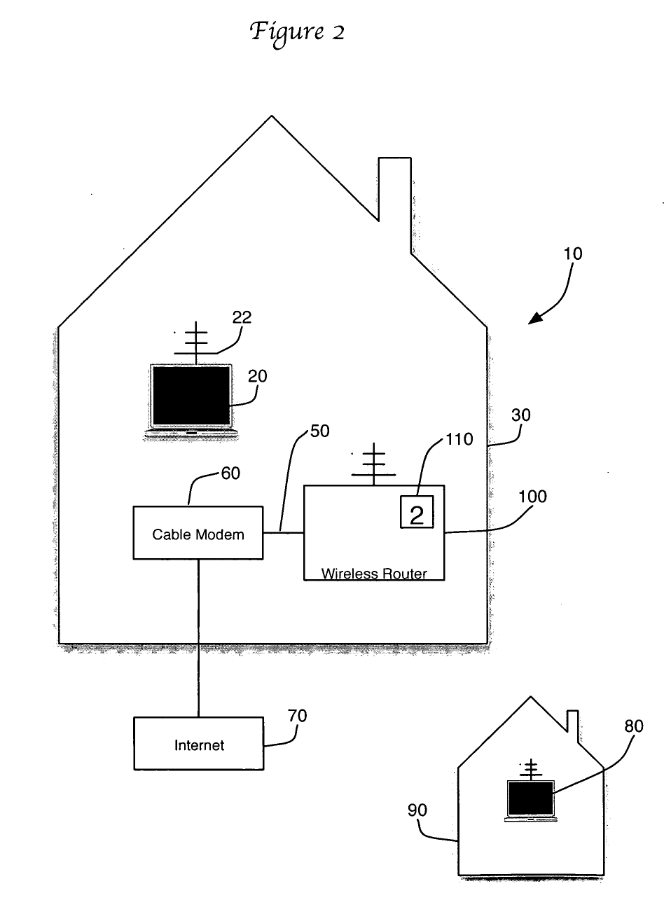

FIG. 2 shows the home network 10 of FIG. 1, with the prior art router 40 being replaced by the wireless router 100 of the present invention. As was the case in FIG. 1, both the intended portable computer 20 and the second portable computer 80 have connected to the present invention wireless router 100 in FIG. 2. The difference in FIG. 2 is that the present invention router 100 provides the owner with a visual indicator 110 of the number of connections currently being made to the router 100. The two most important aspects of this present invention indicator 110 are that the indicator 110 is visible upon examination of the external housing 120 that contains the circuitry of the wireless router 100, and that the indicator 110 clearly indicates the current number of connections being made to the router 100. In this case, the owner can examine the indicator 110 without operating any software on a general-purpose computer, and can easily determine that two connections are currently being made to the wireless router 100. Since only one wireless computer 20 exists in the owner's home 30, the owner now realizes that an outside computer 80 is making a connection to his or her wireless router 100. At this point, the owner can implement security protocols provided on almost all wireless routers 100 so as to block unwanted access to the router 100. Without the indicator 110, the owner would not have known about the unwanted access, and would not have investigated how to implement the appropriate security measures.

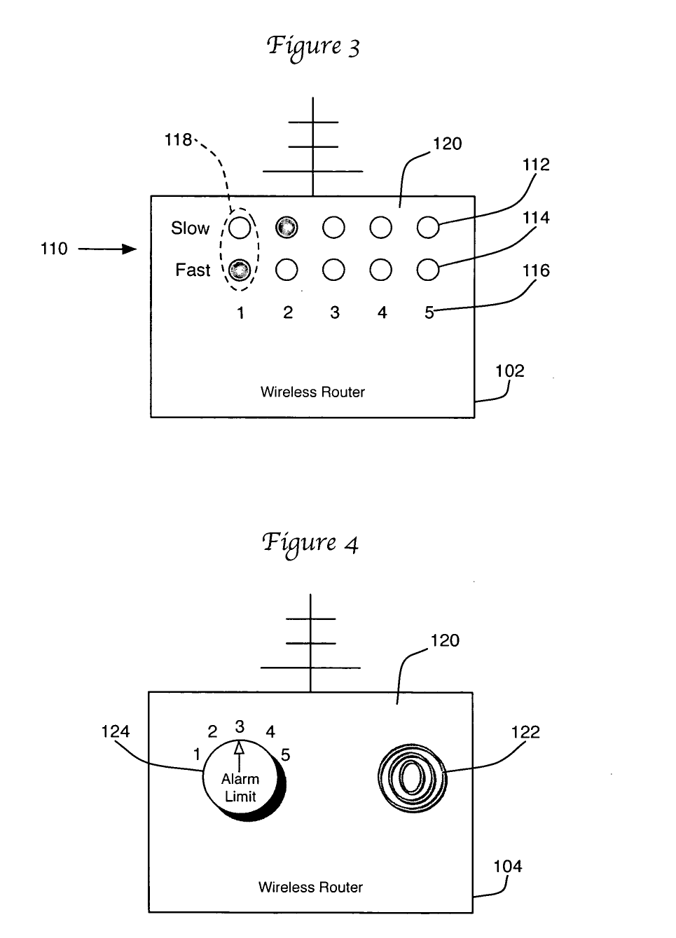

In the embodiment shown in FIG. 2, indicator 110 is shown as a digital numeric display that shows one or more numerals indicating the total number of connections currently made to the router 100. Other types of indicators 110 are possible, such as the plurality of separate lights or LEDs 112, 114 shown in the alternative embodiment router 102 of FIG. 3. The lights 112, 114 of router 102 are grouped in pairs according to connection numbers 116. In the router 102 shown in FIG. 3, only a single light 112, 114 of each pair will be lit at a time, with the light indicating the connection speed of that connection. For instance, lights 112 indicate a slow connection (such as a 802.11(b) connection), while lights 114 indicate a fast connection (such as a 802.11(g) connection). The lights or LEDs associated with each connection number 116 form a set of lights 118 for each connection. If the wireless router 102 supported more protocols and connection speeds, then more lights would be added for each set of lights 118. It is also possible to use multiple lights for each connection number 116 with the separate lights being indicative of signal strength as opposed to connection speed or type. In this case, it may be useful to light multiple lights in a set 118 to indicate a stronger signal, so that the number of connections would be determined by counting illuminated light sets 118 as opposed to counting each separate light. Alternatively, each connection can be represented by a single light (each set 118 has only a single light), with no differentiation made for the type or quality of connection made.

If a connection number 116 does not have any lit LEDs 112, 114 associated with it, then there is no corresponding connection to the wireless router 102. Two lights are lit in FIG. 3, namely the fast light 114 associated with connection “1” and the slow light 112 associated with connection “2.” Since no lights are illuminated for connections 3-5, it is clear that only two connections are currently made to router 102. By having a single illuminated light be associated with each separate connection, the lights 112, 114 provide an easily understood visual indicator of separate connections to router 102. Although five pairs of lights 112, 114 are shown in FIG. 3, this number is for illustration purposes only as the actual number of lights 112, 114 available on router 102 can be selected to represent the physical or practical limits of possible wireless connections to the router 102.

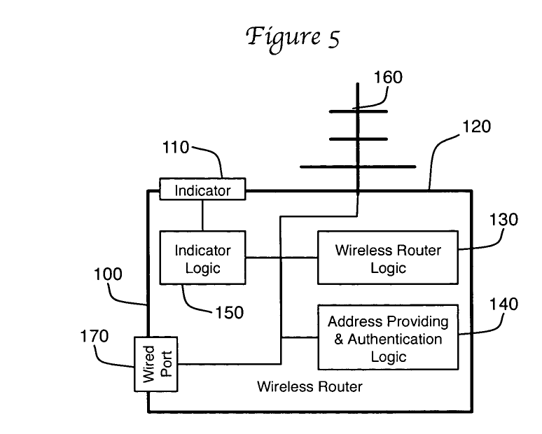

A third embodiment 104 of the present invention is shown in FIG. 4. In this router 104, there is no visual indicator 110 of the number of connections made to the router 104 on external housing 120. In place of indicator 110, the router 104 creates an alarm signal such as an audible alarm on speaker 122. This alarm sounds when the number of connections to the router 104 exceeds an alarm limit. This limit can be set via software using a computer 20 connected to the router 104. In the preferred embodiment, however, the alarm limit is set by an external input 124 on the face of the housing 120. In FIG. 4, this input is shown as a dial 124, however the input could take a variety of forms, including push buttons, flip switches, keyboard entry, or even through a touch-sensitive display. The user of the router 104 inputs the maximum allowed number of connections (the alarm limit) for the router 104 using the input 124. If the number of devices connected to the router 104 exceeds the set alarm limit, the router 104 will set off an alarm signal. In the embodiment 104 shown in FIG. 4, the alarm signal is an audible signal created using speaker 122. Of course, the alarm limit input and audible alarm of this third embodiment 104 can be combined with the visual indicators 110 of the other embodiments 100, 102 to create a router having both a visual indicator 110 and an audible alarm.

The components that make up the wireless router 100 of the present invention are shown in FIG. 5. In particular, the wireless router has an external housing 120 that has an outside surface on which is placed the visual connection indicator 110. The housing 120 contains stand-alone wireless router logic 130 that allows the wireless network 10 to connect to the wired network 50. In addition, the housing contains logic 140 that can provide network addresses to wireless devices. This logic 140 can also serve to allow only authenticated connections to the router 100. As part of the process of providing network addresses or authentication, logic 140 is capable of knowing the number of devices connected to the wireless router 100. This information is provided to the indicator logic 150, which provides the indicator 110 with the signals necessary to properly communicate the number of connected wireless devices to users of the router 100. In addition, the wireless router 100 contains an antenna 160 to receive and transmit wireless signals, and a wired port 170 through which it can connect to the wired network 50. If the router 100 also contains a speaker 122 and an alarm limit input 124, these elements would also be found in FIG. 5 along with alarm logic that would compare the current number of connections against the alarm limit and sound an alarm when appropriate. The logic of the router can take the form of software operating on a CPU, complex programmable logic devices, programmable logic arrays, field programmable gate arrays, application-specific integrated circuits, or any other implementation of digital logic.

This wireless router 100 is referred to as “stand-alone” router 100 with stand-alone wireless router logic 130 because the wireless router 100 is not part of a general-purpose computer. A general-purpose computer is capable of operating productivity software applications, such as word processing, spreadsheet, or database software. To accomplish this, the general-purpose computer operates a general-purpose operating system, provides full user input through a keyboard, and has a general-purpose display controller to provide a display output for the productivity software applications. As a stand-alone device, the router 100 contains only the hardware and programming necessary to perform its function as part of the wireless network 10 and the wired network 50. Productivity applications could not operate on the router 100 since the router 100 does not accept direct keyboard input and a does not contain a general-purpose display controller. This is true even if the stand-alone router 100 uses a microprocessor and an operating system that in another context could be used to operate productivity applications. In addition, the router is typically used in an always-on configuration giving the user a broadband dial tone. Consequently, the indicator 110 will show the number of wireless connections irrespective of which computers are on and off in the network, hence a user will always have access to the connection information regardless of the state of any of the connected computers.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A wireless router comprising:
a) connection tracking logic that allows the wireless router to track a number of wireless devices that are connected to the wireless router;
b) an external housing that contains the address providing logic; and
c) an indicator on an outside surface of the external housing that indicates the number of wireless devices that are connected to the wireless router;
wherein the wireless router is a stand-alone device that does not operate as part of a general-purpose computer.

2. The wireless router of claim 1, wherein the indicator is a digital display.

3. The wireless router of claim 1, wherein the indicator is a plurality of lights.

4. The wireless router of claim 3, wherein the plurality of lights are divided into a plurality of light sets, with each set containing at least one light, and with each set being associated with a separate connection to the wireless router.

5. The wireless router of claim 4, wherein each light set indicates the speed of the connection to the wireless router.

6. The wireless router of claim 5, wherein a separate light in each light set is associated with a different connection speed.

7. The wireless router of claim 5, where each light set indicates the strength of the connection to the wireless router.

8. The wireless router of claim 1 further comprising:
d) wireless router logic within the external housing that connects the wireless network to a wired network.

9. The wireless router of claim 8, further comprising:
e) a plurality of wired ports; and
f) switching logic to provide switch capabilities to the wired ports.

10. The wireless router of claim 1, further comprising:
d) an alarm limit input device on the external housing that allows a user to physically input an alarm limit number; and
e) a speaker that creates an audible alarm when the number of wireless devices that are connected to the wireless router exceeds the alarm limit number.

11. A wireless router comprising:
a) connection tracking logic that allows the wireless router to track a number of wireless devices that are connected to the wireless router;
b) an external housing that contains the address providing logic;
c) an alarm limit input device on the external housing that allows a user to physically input an alarm limit number; and
d) alarm logic that creates an alarm signal when the number of wireless devices that are connected to the wireless router exceeds the alarm limit;
wherein the wireless router is a stand-alone device that does not operate as part of a general-purpose computer.

12. The wireless router of claim 11, further comprising:
e) a speaker that converts the alarm signal into an audible alarm.
